(19) United States
(12) Patent Application Publication
(10) Pub. No.: US 2008/0091635 A1
(43) Pub. Date: Apr. 17, 2008

(54) ANIMATED PICKER FOR SLIDER BARS AND TWO-DIMENSIONAL PICKERS

(75) Inventors: Basonge M. James, Boston, MA (US); Michael H. Jones, Burlington, MA (US); Orlando C. Montavo-Huhn, Ashburnham, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/549,758

(22) Filed: Oct. 16, 2006

(51) Int. Cl. G06F 15/18

(52) U.S. Cl. 706/924

(57) ABSTRACT

A computer program product for facilitating an expression of emotion in an application, is provided and calls for: providing a field for expressing a range of emotions; providing a location indicator for setting a location within the field; associating a unique expression of emotion with each location for the location indicator; and accepting a user input for changing a location of the location indicator to change the unique expression according to the emotion of the user.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to expressing emotion, in particular to expressions of emotion when using particular software applications.

2. Description of the Related Art

A number of software applications call for the entry of an emotional state of a user. For example, some applications query users regarding customer satisfaction, while others seek input regarding medical condition (such as sensations of pain).

Often the choices are presented in a series of radio buttons with a limited number of states. This is not adequate as a way to enter emotional state. There are three main problems. For example, one normally gets a limited set of choices (1-5). One extreme choice being something like “most satisfied”, the other extreme choice being “least satisfied.” Most of the time, 3 represents something to the effect of “neither satisfied nor dissatisfied.” It is frequently the case that a person does not know what to enter, or enters inaccurate information. Additionally, present systems do not provide a clear indication on what option would best fit the users feelings, since there is no feedback. What does it mean to pick 4 instead of 3?

A further issue is that the user may have felt angry for the service, or disappointed or some combination of the two. There is no way to indicate a mixed state or the two types of dissatisfaction.

Application where expression of emotion is an issue are several. For example, applications requiring such input include product or service surveys, emotional state surveys for health, pain surveys for medical reasons and applications working with people who cannot express emotions verbally.

What are needed are techniques for simplifying the selection and input of an emotional state.

### SUMMARY OF THE INVENTION

The shortcomings of the prior art are overcome and additional advantages are provided through the provision of a computer program product including machine readable instructions stored on machine readable media, the product for facilitating an expression of emotion in an application, the instructions for implementing a method including: providing a field for expressing a range of emotions; providing a location indicator for setting a location within the field; associating a unique expression of emotion with each location for the location indicator; and accepting a user input for changing a location of the location indicator to change the unique expression according to the emotion of the user.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which a computer program add-in product including machine readable instructions stored on machine readable media, the product for facilitating an expression of emotion in an application for at least one of a product satisfaction survey, a service satisfaction survey, an emotional state survey, and a pain survey, the instructions for implementing a method including: providing at least one of a one dimensional and a two dimensional field for expressing a range of emotions; providing an emoticon as a location indicator for setting a location within the field; associating one of a predetermined unique expression of emotion and a generated unique expression of emotion with each location for the location indicator; and accepting a user input for changing a location of the location indicator to change the unique expression according to the emotion of the user.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts aspects of a computing infrastructure for implementation of the teachings herein;

FIG. 2 illustrates aspects of a one dimensional depiction of emotional state; and

FIG. 3A through FIG. 3F, collectively referred to herein as FIG. 3, illustrate aspects of a two dimensional system for indicating emotional state.

The detailed description explains the preferred embodiments of the invention, together with advantages and features, by way of example with reference to the drawings.

### DETAILED DESCRIPTION OF THE INVENTION

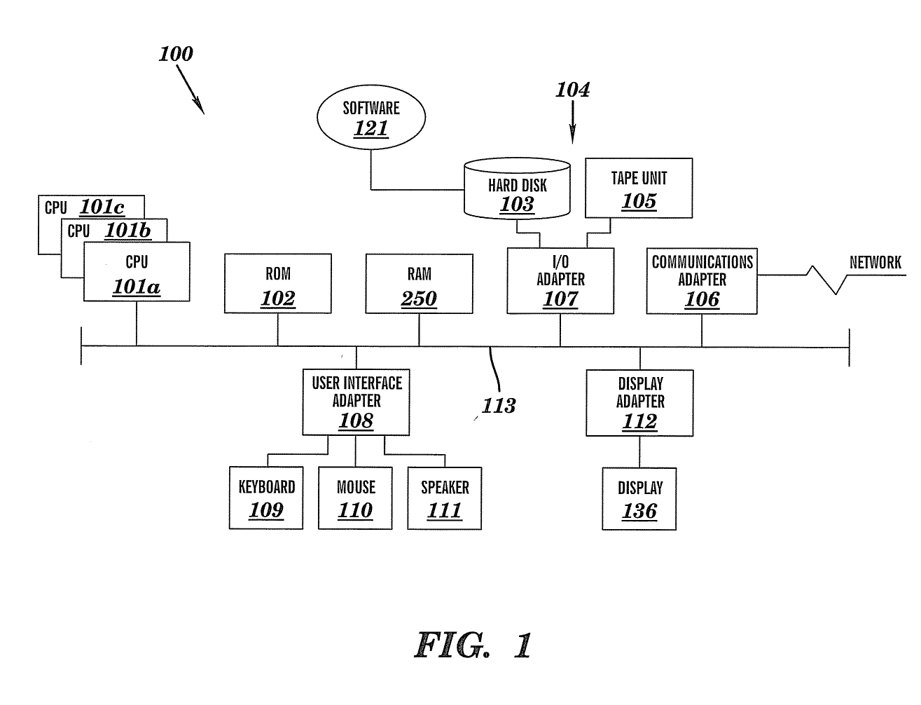

Referring now to FIG. 1, an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 104) for providing personal and emotional expressions of users. As referred to herein, the instructions are referred to as “expressioning” software 121. The software 121 may be produced using software development tools as are known in the art.

Thus, as configured FIG. 1, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

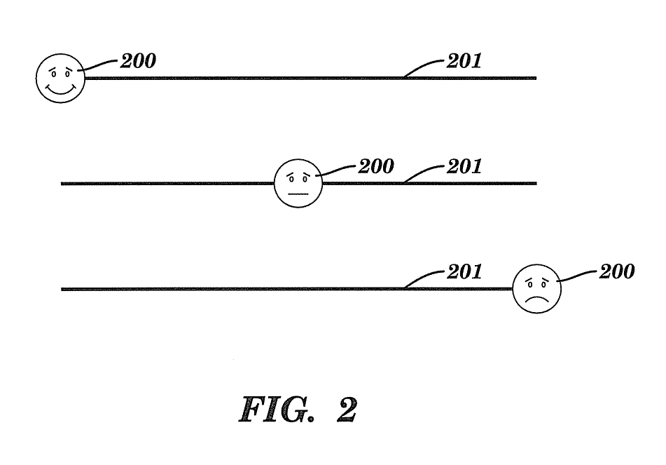

Referring now to FIG. 2, the software 121 provides on-screen indications of emotion. In FIG. 2, a series of scroll bars 201 are provided. In this embodiment, each scroll bar 201 is a horizontal scroll bar 201. However, in other embodiments, the scroll bars 201 have vertical orientations or other orientations. Each of the scroll bars 201 are adorned with an emotional state indication referred to as an “emoticon” 200. The emoticon 200 is provided as an overlay to a location indication, graphical focus indication (or scroll lever), as is known in the art. Examples of location indication devices include boxes within prior art scroll bars.

Using a pointing device, such as the mouse 110, the user manipulates the emoticon 200 for managing location indication. Unlike the prior art location indication devices, the emoticons 200 (according to the teachings herein) provide an indication of emotional state that is associated with a position. For example, with reference to the top scroll bar 201 in FIG. 2, the location of the emoticon 200 indicates a happy emotional state. The location of the emoticon 200 for the bottom scroll bar 201 indicates a sad emotional state. Clearly, the emotion indicated in the middle example is somewhere in between happy and sad.

The teachings provide for using selection and positioning devices, such as the scroll lever, to indicate emotional state. The indication is provided in familiar terms, such as a face, using techniques such as emoticons 200. As one moves the scroll lever, the face goes through a series changes that show a range of emotions or feelings. For example, in case of pain, one end could show a happy face, and the other end could show a crying face. As one moves the face along the scroll bar 201, the face will change and go through a range between these two end states.

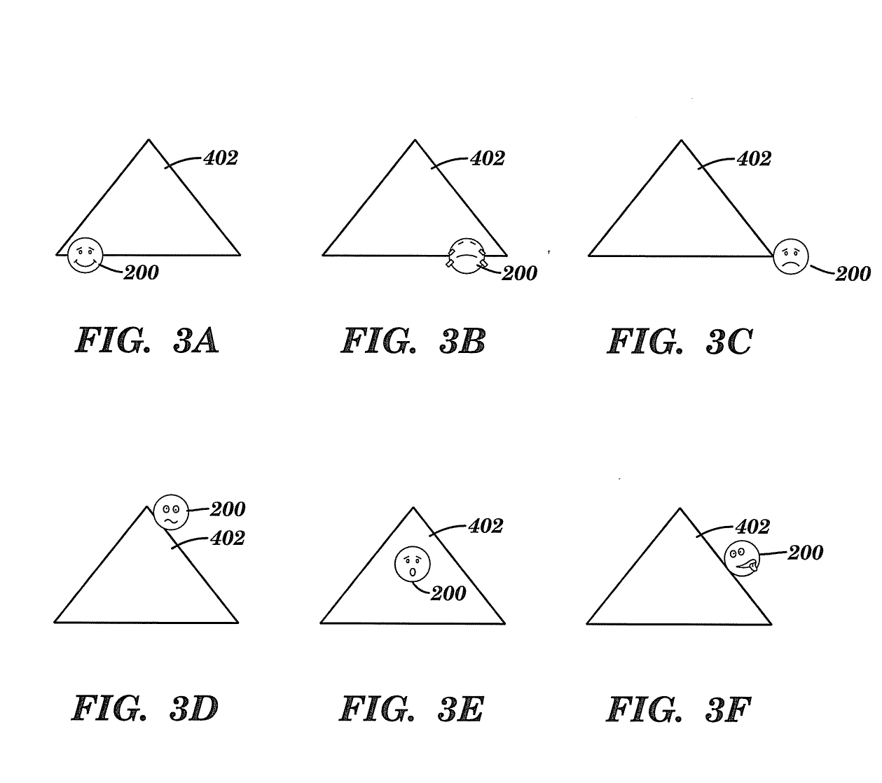

The teachings are not limited to one dimension. For example, two dimensions (such as by use of a triangular or square area) may be used. Using two dimensions allows the user to choose a mix of emotions. Reference may be had to FIG. 3.

In FIG. 3, a two dimensional system 402 is provided. In the two dimensional system 402, various emotional states are depicted. That is, as the emoticon 200 is moved about within the two dimensional system 402, various emotions are indicated by the emoticon 200.

One technique for providing the various emotional states includes providing an association between a location in the two dimensional system 402 with a particular appearance for the emoticon 200 (i.e., a table of emoticons 200). Another technique calls for use of a morphing program for providing modification during movement (i.e., generating the emoticon 200). That is, users are typically provided with a system that provides a dynamic indication of emotion using the emoticon 200.

One skilled in the art will recognize that a few emotional states may be provided in some embodiments. In other embodiments, a great number of emotional states may be accounted for. For example, when using an emoticon 200, the emoticon may appear to be animated when the location is changed.

For simplicity, it is considered that the scroll bar 201 and the two dimensional system 402 each provide a “field” for expressing emotional state. The software provides unique indicators (e.g., emoticons 200) for each position within the field.

Further, one skilled in the art will recognize that data may be obtained from the emoticon 200. That is, the selected position for the emoticon 200 may be accorded a certain value. For example, an angry expression may be correlated to a “strongly dissatisfied” classification of the prior art.

As pointed out above, the software 121 may be used to provide valuable input regarding product satisfaction surveys, service satisfaction surveys, emotional state surveys for health, pain surveys, and expressions of emotion for people who cannot express emotions verbally.

In some embodiments, the software 121 provides a location indicator as an overlay to an application generated location indicator. For example, the software 121 may be provided as an “add-in” to an application (where “add-in” is taken to mean supplemental program code as is known in the art). In such embodiments, the software 121 replaces structures of the application for providing the emotional input described herein.

The software 121 typically provides instruction for providing a field for expressing a range of emotions; providing a location indicator for setting a location within the field; associating a unique expression of emotion with each location for the location indicator; and accepting a user input for changing a location of the location indicator to change the unique expression according to the emotion of the user.

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product comprising machine readable instructions stored on machine readable media, the product for facilitating an expression of emotion in an application, the instructions for implementing a method comprising:
providing a field for expressing a range of emotions;
providing a location indicator for setting a location within the field;
associating a unique expression of emotion with each location for the location indicator; and
accepting a user input for changing a location of the location indicator to change the unique expression according to the emotion of the user.

2. The computer program product as in claim 1, wherein the field comprises a one dimensional field.

3. The computer program product as in claim 1, wherein the field comprises a two dimensional field.

4. The computer program product as in claim 1, wherein the location indicator comprises an emoticon.

5. The computer program product as in claim 1, wherein the field comprises a scroll bar.

6. The computer program product as in claim 1, wherein the application comprises an application for at least one of a product satisfaction survey, a service satisfaction survey, an emotional state survey, and a pain survey.

7. The computer program product as in claim 1, wherein the unique expression is predetermined for each location.

8. The computer program product as in claim 1, wherein the unique expression is generated for each location.

9. The computer program product as in claim 1, wherein the providing a location indicator comprises providing an overlay to an application generated location indicator.

10. The computer program product as in claim 1 as an add-in to the application.

11. A computer program add-in product comprising machine readable instructions stored on machine readable media, the product for facilitating an expression of emotion in an application for at least one of a product satisfaction survey, a service satisfaction survey, an emotional state survey, and a pain survey, the instructions for implementing a method comprising:
providing at least one of a one dimensional and a two dimensional field for expressing a range of emotions;
providing an emoticon as a location indicator for setting a location within the field;
associating one of a predetermined unique expression of emotion and a generated unique expression of emotion with each location for the location indicator; and
accepting a user input for changing a location of the location indicator to change the unique expression according to the emotion of the user.
